(19) United States
(12) Patent Application Publication
(10) Pub. No.: US 2010/0164716 A1
(43) Pub. Date: Jul. 1, 2010

(54) SYSTEM AND METHOD FOR MONITORING DISPENSING OF MEDICATION

(76) Inventors: Leonardo William Estevez, Rowlett, TX (US); William Robert Krenik, Garland, TX (US)

Correspondence Address: TEXAS INSTRUMENTS INCORPORATED, P O BOX 655474, M/S 3999, DALLAS, TX, 75265, US

(21) Appl. No.: 12/416,227

(22) Filed: Apr. 1, 2009

Related U.S. Application Data
(60) Provisional application No. 61/141,832, filed on Dec. 31, 2008.

(51) Int. Cl. G08B 21/00; G06F 17/00; B65D 83/00

(52) U.S. Cl. 340/540; 700/244; 221/2

(57) ABSTRACT

A system is capable of monitoring dispensing of medication from a medication container having a volume. The system comprises a measuring portion and a processor portion. The measuring portion is operable to measure a parameter at a first time and to measure the parameter at a second time. The processor portion is in communication with the measuring portion. The processor portion is operable to determine a change in volume of medication within the medication container based on the measured parameter at the first time and the measured parameter at the second time.

The present application claims benefit under 35 U.S.C. §119 (e) to U.S. provisional patent application 61/141,832, filed Dec. 31, 2008, the entire disclosure of which is incorporated herein by reference.

### BACKGROUND

Proper use of prescription medication is very important. Some patients who have been prescribed medication may sometimes fail to take prescribed amounts of medication at prescribed intervals. This behavior may lessen or negate the intended effect of the prescribed medication. For example, some patients may unknowingly, or forget, to take medication or may take an incorrect quantity of medication. Further, other patients may refuse to take prescribed medication. In either situation, family members or doctors may want or need to ensure that the patient takes the medication as prescribed.

Additionally, individuals may attempt to steal a patient's medication for illicit purposes. For example, a teenager may attempt to take prescription pain medication prescribed to a parent for personal abuse or to sell to others.

What is needed is a medication container that is operable to provide reminders to take prescribed quantities medication at prescribed times or intervals, provide information to a remote party regarding improper access to medication, provide indication to a remote party as to whether or not medication has been dispensed in accordance with a the prescription, and prevent access to medication by unauthorized individuals.

### BRIEF SUMMARY

An aspect of the invention includes a system and method that is operable to provide reminders to take prescribed quantities medication at prescribed times or intervals, provide information to a remote party regarding improper access to medication, provide indication to a remote party as to whether or not medication has been dispensed in accordance with a the prescription, and prevent access to medication by unauthorized individuals

In accordance with an aspect of the present invention, a system and method monitor a patient's consumption of medication.

In accordance with another aspect of the present invention, a system and method alerts others, e.g. family members of a patient and physicians of a patient, of the patients medication consumption compliance.

In accordance with an aspect of the present invention, a system is operable to monitor dispensing of medication from a medication container having a volume. The system comprises a measuring portion and a processor portion. The measuring portion is operable to measure a parameter at a first time and to measure the parameter at a second time. The processor portion is in communication with the measuring portion. The processor portion is operable to determine a change in volume of medication within the medication container based on the measured parameter at the first time and the measured parameter at the second time.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an example embodiment of a medication monitor in accordance with an aspect of the present invention;

FIG. 2A illustrates an example embodiment of the present invention using pressure to measure change in internal quantity in an open position;

FIG. 2B illustrates an example embodiment of the present invention using pressure to measure change in internal quantity in a closed position;

FIG. 3A illustrates an example embodiment of the present invention using weight to measure change in internal quantity;

FIG. 3B illustrates an example embodiment of the present invention using weight to measure change in internal quantity; and

FIG. 4 illustrates a flow diagram detailing an example process of operation of the present invention.

### DETAILED DESCRIPTION

In accordance with aspects of the present invention, medication dispensing may be automatically monitored by means of a measurement device internal to the medication bottle. In one embodiment, a parameter is measured that is related to the quantity of medication within the medication bottle, non-limiting examples of which parameters include time, mass, volume and pressure.

In accordance with another aspect of the present invention, medication dispensing may include indicators for any one of the owner of the medication, family members, friends and health care providers. This aspect addresses those prescription owners that may unknowingly fail to comply with a medication prescription. Some patients may forget to take medication, may forget to take medication at the required time, or may forget that they have already taken medication recently. Indictors may then alert the user to the correct time to take the medication and therefore decrease the likelihood the patient will unknowingly fail to take their medications. Non-limiting examples in indicators include visual indicators such as flashing lights and auditory indicators such as alarms and buzzers.

In accordance with another aspect of the present invention, medication dispensing may be indicated to individuals other than the patient to address users who willingly fail to comply with the medication prescription. Some patients may refuse to take prescribed medication because of side effects. With such patients, an indication may be sent to another individual, such as a friend, family member or health care provider, to monitor the patient's prescription habits in order to take corrective action.

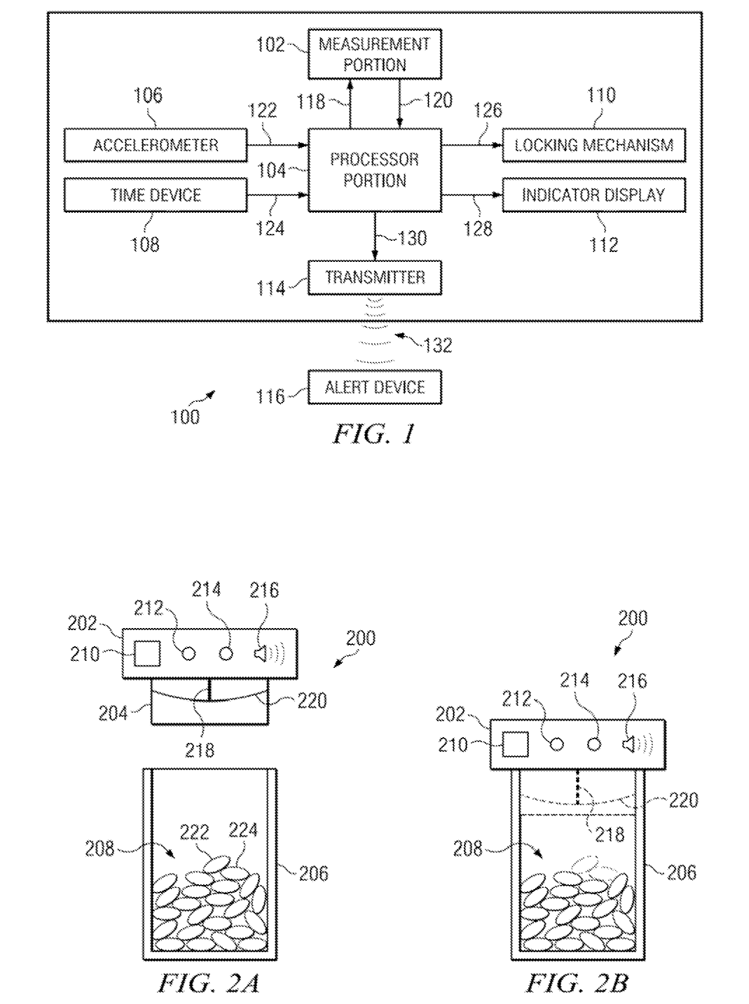

An example embodiment of a medication monitor in accordance with an aspect of the present invention will now be described with reference to FIG. 1.

As illustrated in the figure, a medication monitor 100 includes a measurement portion 102, a processor portion 104, an accelerometer 106, a time device 108, a locking mechanism 110, an indicator 112 and a transmitter 114. Medication monitor 100 is operable to communicate with an alert device 116.

Medication monitor 100 may be a unitary device, wherein each of measurement portion 102, processor portion 104, accelerometer 106, time device 108, locking mechanism 110, indicator 112 and transmitter 114 are a single device. In some embodiments, medication monitor 100 is not a unitary device, wherein at least one of measurement portion 102, processor portion 104, accelerometer 106, time device 108, locking mechanism 110, indicator 112 and transmitter 114 are a separate device.

In some embodiments, a medication monitor in accordance with an aspect of the present invention may not include each of measurement portion 102, processor portion 104, accelerometer 106, time device 108, locking mechanism 110, indicator 112 and transmitter 114 are a single device. In a general embodiment, a system for monitoring dispensing of medication from a medication container having a volume includes measurement portion 102 and processor portion 104.

Measurement portion 102 may be any device, structure or system that is operable to detect a change in a measurable quantity associated with medication monitor 100. Non-limiting examples of a measurable quantity include weight, volume and pressure. Non-limiting examples of measurement portion 102 include a mechanical scale measuring change in weight or an expandable diaphragm which detects a change in pressure proportional to the change in volume using the ideal gas law. Measurement portion 102 can detect a change in a measured quantity inside a container and generate a detected signal 120 corresponding thereto.

Accelerometer 106 may be any device, structure or system that is operable to sense acceleration of medication monitor 100 thus generating a signal 122. Signal 122 alerts enables processor portion 104 to perform functions including instructing measurement portion 102 to take measurements. Acceleration detected by accelerometer 106 may also be used to determine that medication monitor 100 has stopped moving and is oriented in a predetermined position. Accelerometer 106 may be included in embodiments of the present invention wherein the measureable quantity inside a container that is to be measured includes at least one of weight and pressure, as will be discussed in more detail below.

In some embodiments of the present invention, it may be important for medication monitor 100 to monitor time intervals between medications or the time a medication is dispensed. Certain medications may need to be taken at specific times of day or may need to be taken at specific intervals for the medication to be effective. In some embodiments, the specific time or time interval may be preprogrammed within medication monitor 100 by a pharmacist, doctor or other individual. In other embodiments, medication monitor 100 may learn the time or time interval upon repeated use of medication monitor 100. Medication monitor 100 may learn the time or time interval by using any conventional learning algorithm to keep track of the patient's access to medication monitor 100 and learn the appropriate time or time interval. When medication monitor 100 has a preprogrammed or learned time interval for dispensing medication, medication monitor 100 may provide an indication to the user to take medication at the correct time.

A device may be needed to alert the user it is time to take medication. Other embodiments may need a system to first determine the time or time interval to take medication and then use the determined time or time interval to alert the user it is time to take medication. A non-limiting example of such a system includes a clock or a timer and a processing unit that is operable to learn a time or time interval of medication with successive use of medication monitor 100 and then use the learned time or time interval to indicate time to take medication.

Time device 108 may be any device, structure or system that is operable to detect time or learn a time interval based on repetition. Once repetitive time intervals are learned, signal 124 is generated to provide alerts if movement and measurements are not taken within a certain time period, which will be discussed in more detail below.

In some instances, it may be necessary to lock a medication container. Sometimes, a patient cannot be trusted due to altered stated of mind, such as those patients with dementia or Alzheimer's disease. Additionally, there may be other individuals who may attempt to access the medication without authorization. In these cases, it may be beneficial to permit access to the medication only at times it is to be dispensed. Therefore some embodiments of the present invention may include a locking mechanism 110. Non-limiting examples of which may include a time-release lock and locking mechanism that may be unlocked via a signal internal to medication monitor 100 or via a signal from a third party, such as a doctor.

Locking mechanism 110 may be any device, structure or system that is operable to prevent unauthorized access to contents within the medication monitor 100. Non-limiting examples include simple memory alloys (SMA's) used to release a latch and enable access to the contents of the container only after certain criteria are met, such criteria are discussed about in more detail later. Locking mechanism 110 may inhibit access to the container because of orientation or movement detected by accelerometer 106, measured change as detected by measurement portion 102, or a time interval as detected by time device 108.

Some patients may require a reminder that it is time to take medication. Reminders may take the form of at least one of a visual indicator and audio tone. For example, in some embodiments, a light may illuminate when it is time for a patient to take medication. In other embodiments, a tone may sound when it is time to take medication. In still other embodiments, a light may illuminate and a tone may sound when it is time to take medication.

Indicator 112 may be any device, structure or system that is operable to indicate a parameter. In some embodiments, the indicator 112 includes an indicator operable to indicate to a user of a medication container having medication monitor 100 as to whether contents of the container should (or should not) be taken based on learned time intervals or changes in a measured quantity. Non-limiting examples include numbers, colors, Light Emitting Diodes (LED's), lasers, images or sound devices.

Processor Portion 104 may be any device, structure or system that is operable to correlate appropriate measured changes via signal 120, movement and orientation of the medication monitor 100 via signal 122 and time interval via signal 124. Processor portion 104 learns patterns in measured changes via signal 120 and patterns in time interval via signal 124 and generates positive or negative alerts via signals 128 and 130 or controls locking mechanism 110 via signal 126.

As briefly discussed above, some embodiments of the present invention may require a method for remote notification of medication access or compliance. For example, patients may not want to take prescribed medication for many reasons, such as unwanted side effects of the medication. Further, a patient may want to be notified if and when others gain access to the medication. In these instances, a family member or doctor may wish to be notified that a patient has taken medication as prescribed or a patient may wish to be notified when their medication is accessed. A transmitter 114 may send a signal to a remote party to indicate access to medication or whether or not medication has been taken as prescribed. Additionally, an alert device 116 may receive a signal from transmitter 114 and subsequently provide an indication to the remote party.

Transmitter 114 may be any device, structure or system that is operable to provide a signal 132 to remotely communicate with alert device 116. A non-limiting example of transmitter 114 includes a low power radio frequency (RF) transmitter.

Alert device 116 may be any device, structure or system that is operable to receive signals transmitted from medication monitor 100 and provide an alert or re-transmit signal 132 to another device. Non-limiting examples of alert device 116 include a mobile phone or wireless enabled watch which can subsequently communicate with a mobile phone or computer. Signal 132 provides information including, but not limited to, whether proper quantities of medication were taken, whether medication was taken at proper time intervals, and whether orientation of medication monitor 100 is correct.

Two working example embodiments of medication monitors in accordance with aspects of the present invention will now be described with reference to FIGS. 2A-4.

FIGS. 2A and 2B are two dimensional views of a working example embodiment of a medication monitor in accordance with an aspect of the present invention. FIG. 2A shows a pill container 200 in an open position. Pill container 200 includes a medication monitor 202, corresponding to medication monitor 100 of FIG. 1. Medication monitor 202 includes: a measurement portion 204, which corresponds to measurement portion 102 of FIG. 1; a transmitter 210, which corresponds to transmitter 114 of FIG. 1; and a green LED 212, a red LED 214, and an audible alarm 216, which correspond to indicator 112 of FIG. 1. A processor portion, a time device, and an accelerometer for medication monitor 202, which correspond to processor portion 104, time device 108, and accelerometer 106 of FIG. 1, are disposed within medication monitor 202 and are not shown in FIGS. 2A and 2B. A bottle 206 is used to hold medicine 208, which includes pills 222 and 224, and attaches to medication monitor 202 to form an airtight seal as shown in FIG. 2B.

Measurement portion 204 includes a spring 218 and a diaphragm 220 that may be used to measure a change in volume of bottle 206, when pill container 200 is sealed as in FIG. 2B. Different quantities of medicine 208 in bottle 206 will result in a different force and/or different compression length of spring 218 allowing medication monitor 202 to detect the change in the quantity of pills contained in bottle 206. Specifically, measurement portion 204 can detect when pills 222 and 224 have been removed, as illustrated by the dotted lines in FIG. 2B.

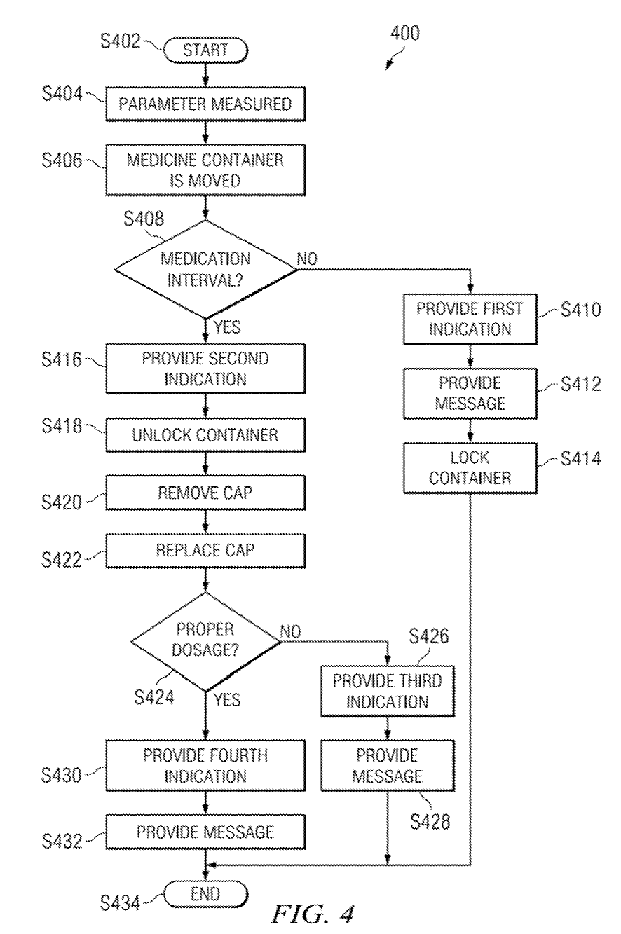

Operation of medication monitor 202 will now be described with reference to FIGS. 2A, 2B and 4. FIG. 4 is a logic flow diagram describing an exemplary method of operation of medication monitor 202.

To start (S402), the need to automatically monitor the consumption of medications in the form of medication 208 is desired. Medication monitor 202 is attached to bottle 206 and is in a steady state position as shown in FIG. 2B.

Next, measurement portion 204 measures a parameter (S404) of bottle 206. In an example embodiment, the measured parameter is pressure within bottle 206. In some embodiments, pressure within bottle 206 is measured and a volume is calculated via the ideal gas law using the formula PV=nRT. For example, when medication monitor 202 is placed on bottle 206, a spring 218 may be released, thereby forcing down diaphragm 220 to compress a known amount of air volume in bottle 206. The pressure inside bottle 206 is related to the volume of bottle 206 that is unoccupied by medication 208.

Using the ideal gas law, the pressure inside bottle 206 for a given amount of medication can be calculated. Let bottle 206 have an empty internal volume of V_{bottle}. A quantity of medication has an associated volume, namely if an individual pill has a volume Vₚᵢₗₗ the medication takes up a volume of V_{med}=k*Vₚᵢₗₗ, where k is the number of pills. Let Vₑ be the amount of volume that diaphragm 220 compresses.

In the ideal gas law, n represents the number of moles of gas (air) inside the container, R is the universal gas constant, and T is the absolute temperature. When diaphragm 220 compresses the air inside container, n and T in the ideal gas law can be taken as constant, since no air can be added and the associated temperature change is very small. Now. n, R, and T are constant, so PV=constant. When bottle 206 is open, the pressure is just atmospheric pressure Pₐₜₘ. To find the internal pressure Pᵢ, use PV=constant. Plugging in values for before and after the contents of bottle 206 are compressed by diaphragm 220,

Pₐₜₘ*(V_{bottle}−V_{med})=Pᵢ*(V_{bottle}−V_{med}−Vₑ).

Let the internal pressure Pᵢ. Here

Pᵢ=Pₐₜₘ*(V_{bottle}−V_{med})/(V_{bottle}−V_{med}−Vₑ).

Different quantities of medicine 208 displace different volumes V_{med}, and give different internal pressures Pᵢ. Specifically, larger quantities of medicine 208 result in higher internal pressures Pᵢ.

Operation of medication monitor 202 will now be described with reference to FIGS. 2A, 2B and 4.

After the initial parameter measurement in step S404, medication monitor 202 waits until movement is detected (S406). Medication monitor 202 determines if an acceptable time interval has passed between medications (S408). In some embodiment, the time interval between medications is compared to a predetermined time, for example, four hours.

If it is not time to take medication, a first indication is provided (S410). Non-limiting examples of the first indication include providing at least one of a visual and an audible indication. In an example embodiment, red LED 214 is illuminated and an audible alert is sounded via alarm 216. Additionally, in some embodiments, a message indicating improper access of container 200 may be transmitted (S412) via transmitter 210.

Next, if container 200 is not locked then it is automatically locked (S414) and the process ends (S434).

Returning back to the decision in step S408, if it is time to take medication, for example, the time interval from the last dispensing of medications is determined to be longer than a predetermined time, a second indication is provided (S416). In an example embodiment, green LED 212 is illuminated and an audible alert is sounded via alarm 216. In some embodiments, the audible alert corresponding to step S410 is the same as the audible alert corresponding to step S416. In other embodiments, the audible alert corresponding to step S410 is different from the audible alert corresponding to step S416.

Container 200 is then unlocked (S418). Medication monitor 202 is separated from bottle 206 (S420) and medication, pills 222 and 224, are removed. Medication monitor 202 is then rejoined to bottle 206 (S422) and container 200 is placed in the correct orientation.

Measurement portion 204 measures pressure inside bottle 206 to determine whether the proper dosage of medication has been taken (S424). The change in pressure from step S404 to S424 indicates the number of pills removed, if the quantity of removed medication is incorrect, a third indication is provided (S426). In an example embodiment, red LED 214 is illuminated and an audible alert is sounded via alarm 216. In some embodiments, the audible alert corresponding to step S426 is the same as the audible alert corresponding to at least one of step S410 and step S416. In other embodiments, the audible alert corresponding to step S426 is different from both the audible alerts corresponding to step S410 and step S416. Additionally, in some embodiments, a message indicating improper dosage is transmitted (S428) via transmitter 210 and the process ends (S434).

Returning back to the decision in step S424, if the quantity of medication removed is correct, a fourth indication is provided (S430). In an example embodiment, green LED 212 is illuminated and an alert is sounded via alarm 216. In some embodiments, the audible alert corresponding to step S430 is the same as the audible alert corresponding to at least one of step S410, step S416 and step S426. In other embodiments, the audible alert corresponding to step S430 is different from the audible alerts corresponding to step S410, step S416 and step S426. Additionally, in some embodiments, a message indicating medication has been taken correctly is transmitted (S432) via transmitter 210 and the process ends (S434).

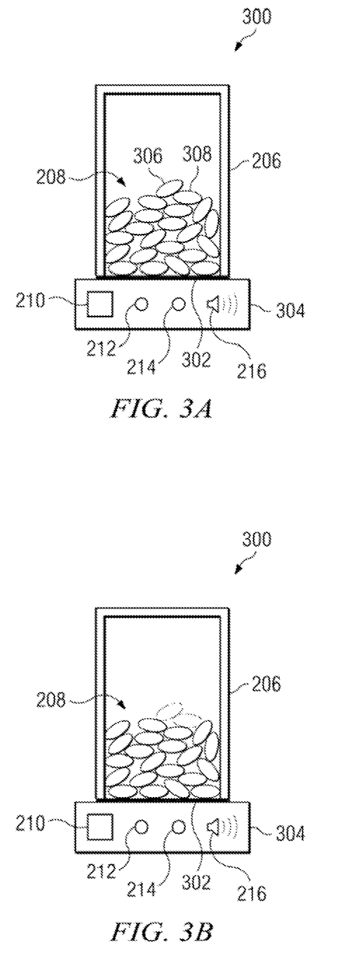

FIGS. 3A and 3B are two dimensional views of another working example embodiment of a medication monitor in accordance with an aspect of the present invention. FIGS. 3A and 3B show pill container 300 containing medicine 208. Pill container 300 includes medication monitor 304 corresponding to medication monitor 100 of FIG. 1. Medication monitor 304 includes: a measurement portion 302, which corresponds to measurement portion 102 of FIG. 1; transmitter 210, green LED 212, red LED 214, and audible alarm 216. A processor portion, a time device, and an accelerometer for medication monitor 304, which correspond to processor portion 104, time device 108, and accelerometer 106 of FIG. 1, are disposed within medication monitor 304 and are not shown in FIGS. 3A and 3B. Bottle 206 is used to hold medicine 208 and attaches to medication monitor 304 to form an airtight seal.

Measurement portion 302 may be a scale that may be used to measure a change in weight of the medicine in bottle 206. In FIG. 3A, bottle 206 contains medicine 208, which includes pills 306 and 308. Measurement portion 302 can measure the weight of medicine 208, which includes the weight of pills 306 and 308. In FIG. 3B, bottle contains medicine 208, wherein pills 306 and 308 have been removed. In such an instance, measurement portion 302 will measure the remaining weight of medicine 208.

Operation of medication monitor 304 will now be described with reference to FIGS. 3A, 3B and 4.

To start (S402), the need to monitor the consumption of medication 208 is desired. Medication monitor 304 is attached to bottle 206 and is in a steady state position as shown in FIG. 3BA.

Next, measurement portion 302 measures a parameter (S404) inside bottle 206. In the exemplary embodiment shown in FIGS. 3A and 3B, the measured parameter is weight, wherein measurement portion 302 acts as a scale. Container 300 is placed with medication monitor 304 side down to give a proper reading. Measurement portion 302 can detect change in quantity of medicine 208 by detecting the change in weight inside bottle 206.

After the initial parameter measurement in step S404, steps S408 through S422 may be performed in a manner similar to those discussed above with reference to the embodiment illustrated in FIGS. 2A and 2B.

Once, medication monitor 304 is then rejoined to bottle 206 (S422) and container 300 is placed in the correct orientation, measurement portion 204 measure the weight inside bottle 206 to determine whether the proper dosage of medication was taken (S424). The change in weight from step S404 to S424 should be directly related to the number of pills removed.

After the determination in step S424, steps S426 through S434 may be performed in a manner similar to those discussed above with reference to the embodiment illustrated in FIGS. 2A and 2B.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A system for monitoring dispensing of medication from a medication container having a volume, said system comprising:
a measuring portion operable to measure a parameter at a first time and to measure the parameter at a second time;
a processor portion in communication with said measuring portion, said processor portion being operable to determine a change in volume of medication within the medication container based on the measured parameter at the first time and the measured parameter at the second time.

2. The system of claim 1, wherein said measuring portion is operable to measure a volume of medication within the medication container at the first time and to measure the volume of medication within the medication container at the second time.

3. The system of claim 2,
wherein said measuring portion comprises a pressure sensor operable to measure a first pressure within the medication container at the first time, to generate a first pressure signal based on the measured first pressure, to measure a second pressure within the medication container at the second time and to generate a second pressure signal based on the measured second pressure,
wherein said processor portion is further operable to determine the change in volume of medication based on the first pressure signal and the second pressure signal.

4. The system of claim 2,
wherein said measuring portion comprises a mass sensor operable to measure a first mass within the medication container at the first time, to generate a first mass signal based on the measured first mass, to measure a second mass within the medication container at the second time and to generate a second mass signal based on the measured second mass,
wherein said processor portion is further operable to determine the change in volume of medication based on the first mass signal and the second mass signal.

5. The system of claim 1, further comprising an indicator operable to provide at least one of an audible indication and a visible indication.

6. The system of claim 5, wherein said processor portion is further operable to instruct the indicator to provide the at least one of an audible indication and a visible indication based on the change in volume of medication.

7. The system of claim 5, wherein said processor portion is further operable to instruct the indicator to provide the at least one of an audible indication and a visible indication based on a period of time.

8. The system of claim 1, further comprising a transmitter operable to transmit a transmission signal.

9. The system of claim 8, wherein said processor portion is further operable to instruct the transmitter to transmit the transmission signal based on the change in volume of medication.

10. The system of claim 8, wherein said processor portion is further operable to instruct the transmitter to transmit the transmission signal based on a period of time.

11. A method monitoring dispensing of medication from a medication container having a volume, said method comprising:
measuring a parameter at a first time;
measuring the parameter at a second time;
determining a change in volume of medication within the medication container based on the measured parameter at the first time and the measured parameter at the second time.

12. The method of claim 11,
wherein said measuring a parameter at a first time comprises measuring a volume of medication within the medication container at the first time, and
wherein said measuring the parameter at a second time comprises measuring the volume of medication within the medication container at the second time.

13. The method of claim 12, further comprising:
generating a first pressure signal; and
generating a second pressure signal,
wherein said measuring a volume of medication within the medication container at the first time comprises measuring a first pressure within the medication container at the first time,
wherein the first pressure signal is based on the measured first pressure,
wherein said measuring the volume of medication within the medication container at the second time comprises measuring a second pressure within the medication container at the second time,
wherein the second pressure signal is based on the measured second pressure, and
wherein said determining a change in volume of medication based on the measured parameter at the first time and the measured parameter at the second time comprises determining the change in volume of medication based on the first pressure signal and the second pressure signal.

14. The method of claim 12, further comprising:
generating a first mass signal; and
generating a second mass signal,
wherein said measuring a volume of medication within the medication container at the first time comprises measuring a first mass within the medication container at the first time,
wherein the first mass signal is based on the measured first mass,
wherein said measuring the volume of medication within the medication container at the second time comprises measuring a second mass within the medication container at the second time,
wherein the second mass signal is based on the measured second mass, and
wherein said determining a change in volume of medication based on the measured parameter at the first time and the measured parameter at the second time comprises determining the change in volume of medication based on the first mass signal and the second mass signal.

15. The method of claim 11, further comprising providing at least one of an audible indication and a visible indication.

16. The method of claim 15, wherein said providing at least one of an audible indication and a visible indication is based on the change in volume of medication.

17. The method of claim 15, wherein said providing at least one of an audible indication and a visible indication is based on a period of time.

18. The method of claim 11, further comprising transmitting a transmission signal.

19. The method of claim 18, wherein said transmitting a transmission signal is based on the change in volume of medication.

20. The method of claim 18, wherein said transmitting a transmission signal is based on a period of time.
